(19) United States
(12) Patent Application Publication
(10) Pub. No.: US 2021/0222892 A1
(43) Pub. Date: Jul. 22, 2021

(54) HEATING AND COOLING WINDOW AIR TREATMENT UNIT

(71) Applicant: NICHOLAS BATTIESE, TORONTO (CA)

(72) Inventor: NICHOLAS BATTIESE, TORONTO (CA)

(21) Appl. No.: 17/155,049

(22) Filed: Jan. 21, 2021

Related U.S. Application Data
(60) Provisional application No. 62/964,569, filed on Jan. 22, 2020.

(51) Int. Cl. F24F 1/027; F24F 1/0284; F24F 1/0323; F24F 13/22; F24F 13/24

(52) U.S. Cl. CPC F24F 1/027; F24F 1/0284; F24F 1/0323; F24F 2221/20; F24F 13/24; F24F 2013/242; F24F 2013/227; F24F 13/224

(57) ABSTRACT

Described herein is a heating/cooling window unit designed to be compact and reversible in operation to provide both heated and cooled air to an indoor room. The heating/cooling device is equipped with a touch control panel, a heat pump, and a set of cooling and circulating fans.

### CLAIM OF PRIORITY

This application claims priority to and the benefit of U.S. Provisional Application with Ser. No. 62/964,569, filed on Jan. 22, 2020, with the same title and is hereby incorporated by reference in its entirety.

### FIELD OF THE INVENTION

The inventive concept relates generally to a heating and cooling window unit.

### BACKGROUND

Currently there are a number of solutions for heating and cooling a room. One of these solutions attempts to utilize central air units and systems, but this solution fails to meet the needs of the market because not all houses are equipped with them nor can be retrofitted into an older home. Another solution attempts to utilize space heaters, but this solution is similarly unable to meet the needs of the market because they can be dangerous and take up valuable indoor living space. Still another solution for older homes seeks to utilize air conditioning units or minisplits or PTAC units, but these solutions also fail to meet market needs because they only produce cold air or require complicated mounting and ductwork installation in some cases. Therefore, there currently exists a need in the market for an apparatus that is both a room heating and cooling unit.

### SUMMARY OF THE INVENTION

There is provided an individual air treatment window unit device or apparatus that is versatile in providing both heating and cooling of air directed to the inside of a home from a window location without the need for complex and expensive ductwork installation. Furthermore, it would also be advantageous to have an air treatment apparatus that is easily removable and can be relocated to another part of the home or office depending on the needs of the user. Still further, it would be advantageous to have an apparatus that is touch controlled. The inventive concept advantageously fills the aforementioned deficiencies by providing a heating/cooling window unit which provides a way for users to heat or cool a room at minimum individual cost and operational costs.

In one example embodiment, there is provided a heating and cooling window unit having a touch control panel electrically coupled to an internal printed circuit board (PCB), having a microprocessor or microcontroller, in the unit housing which in turn is electrically coupled to a heat pump and a fan that moves air over an internally housed coil. The apparatus fulfills the need for a window unit for winter and summer that is quieter than other window units and includes a brightness control panel for ease of use in low light environments.

The air treatment units described herein are an improvement over the prior art in that a belt-driven cross flow fan that allows the unit to be more narrow versus units that use a direct drive cross flow fan with the motor beside the cross flow fan. Further, in one embodiment, an indoor drain port that is on the indoor side of the inventive window/wall unit allows for defrost and condensate water to drain indoors with a drain system. Inverter heat pump compressor technology allows the unit to save energy and operate quieter than traditional compressor technology. It is more cost effective to install the unit described herein using a window heat pump versus a PTAC or through the wall unit. Finally, the units described herein are quieter than a regular window unit.

Among other things, it is an advantage of the inventive concept to provide a heating/cooling window unit that does not suffer from any of the problems or deficiencies associated with prior solutions.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete and will fully convey the full scope of the inventive concept to those skilled in the art.

### BRIEF DESCRIPTION OF THE DRAWINGS

FIG. 1 illustrates a back or rear view of a first embodiment of a single heating and cooling air treatment device configured for installation at a window.

FIG. 2 illustrates a top view of the air treatment device.

FIG. 3 illustrates an exposed top view of the internal components of air treatment device from the front of the unit.

FIG. 4 illustrates a second exposed top view of the air treatment device from the rear of the unit.

FIG. 5 illustrates a front view of the air treatment device and a control panel mounted thereon.

FIG. 6 illustrates a perspective view of the air treatment device.

FIG. 7 illustrates a left side of the air treatment device.

FIG. 8 illustrates a right side of the air treatment device.

FIG. 9 illustrates another embodiment of an air treatment device.

FIG. 10 illustrates an example embodiment of an air treatment device in which a drain pipe is provided for internal drainage of condensate or for connection to existing steam or hot water pipe system.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The inventive concept includes a heating/cooling window unit or air treatment device designed for use as a year-round heating and cooling window unit. In this example embodiment, there is provided a DC inverter window heat pump that features a new component layout, an inverter variable speed compressor with low outdoor temperature performance −13° F. (−25° C.), and a cross flow evaporator fan for much quieter performance than the typical window air conditioner. The inventive component layout allows the evaporator coil, cross flow evaporator fan and top discharge grill to all be the full width of an A/C unit, which allows for a lot more space for air flow. Further, more space for air flow, a belt driven cross flow evaporator fan, and relocation of the control board helps clear up a lot more space for air flow through the evaporator coil. As a direct drive cross flow evaporator fan would normally take up space, with the fan motor being beside the cross flow evaporator fan, which would then block room for airflow, and in some cases make the unit wider than necessary. The full width evaporator coil, and full width cross flow evaporator fan in the inventive air treatment unit and the novel component layout also provides even air distribution through the discharge vent. A low temperature performance DC inverter compressor is used instead of a fixed speed compressor. This will reduce the operating noise of the window heat pump unit, and provide 100% heating capacities at 5° F. (−15° C.) and high heating capacities at −13° F. (−25° C.). The DC inverter window heat pump will provide heating and cooling for year round use, so there is no need to remove the window heat pump unit in the colder seasons.

In the various embodiments described, preferred compressor units for DC inverter window heat pump or device 100 include the Mitsubishi Electric H2i hyper heating inverter compressors (for WINDWORKS 9K-18K BTU units) that are used in the Mitsubishi Electric H2i FH series mini split outdoor units, designed to provide heating in low temperatures, these compressors can operate at outdoor temperatures as low as −13° F. (−25° C.) in heating mode. The preferred compressor for the larger 25K BTU inverter window heat pumps are the compressors used in the SAMSUNG FJM Max Heat unit, with this compressor also operating at temperatures as low as −13° F. (−25° C.). The expected capacities of the inventive inverter window heat pumps are: −6K BTU, 9K BTU, 12K BTU, 18K BTU, 25K BTU, and 28K BTU.

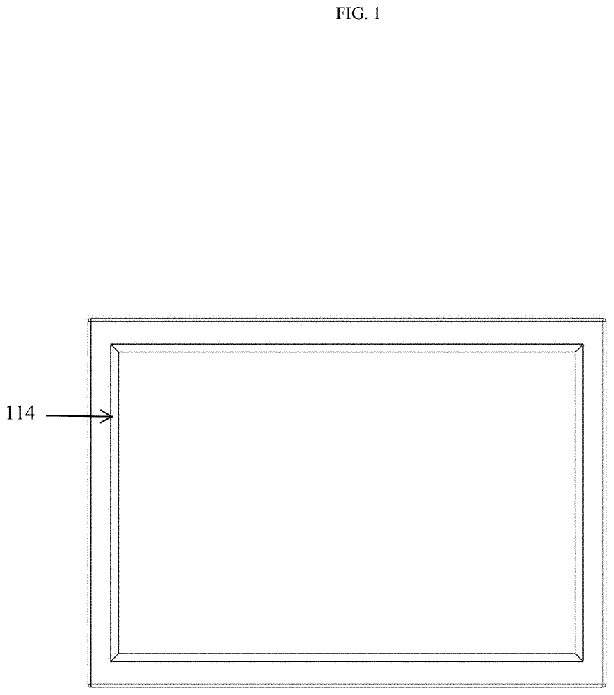

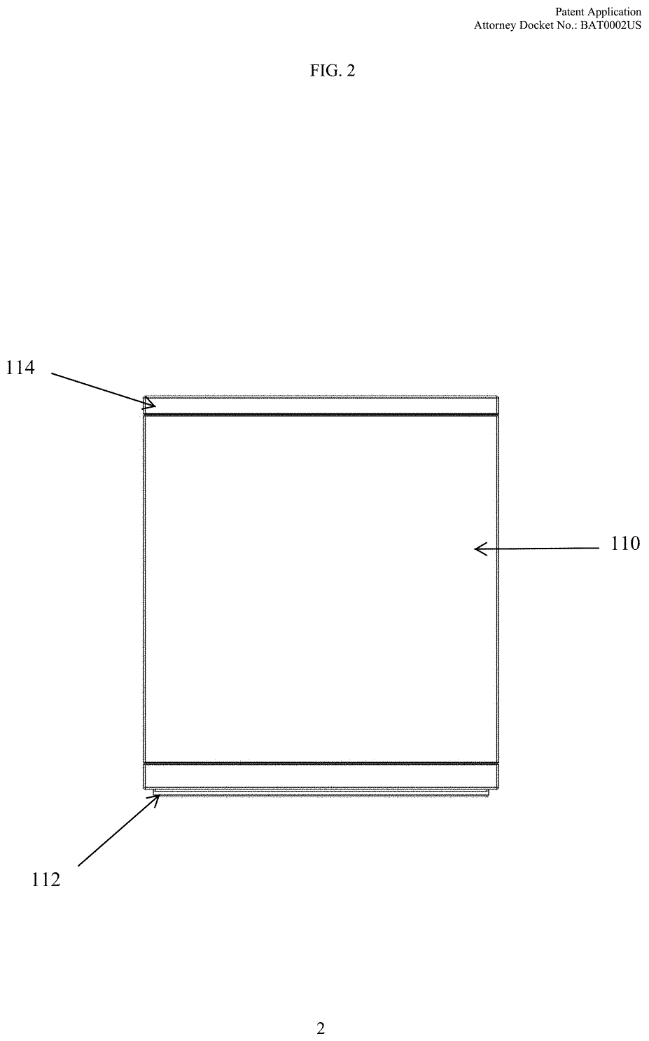

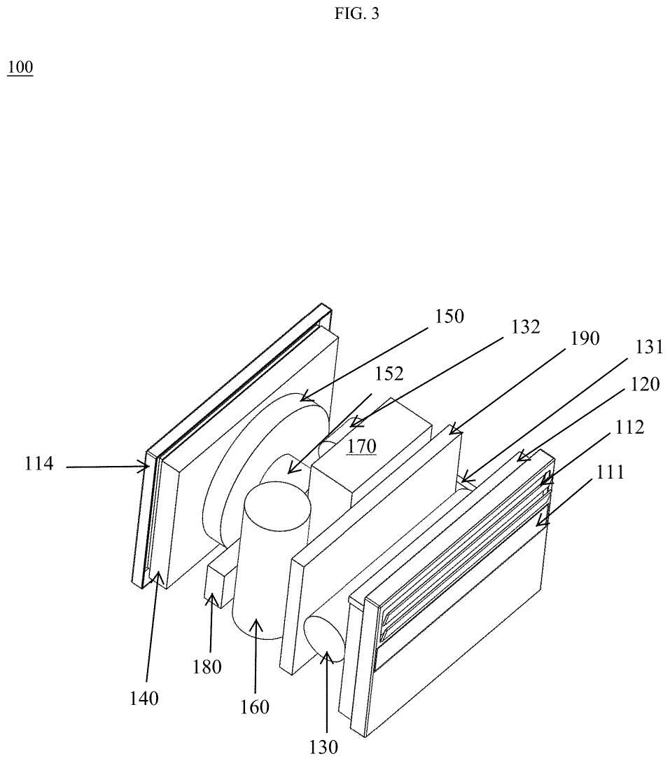

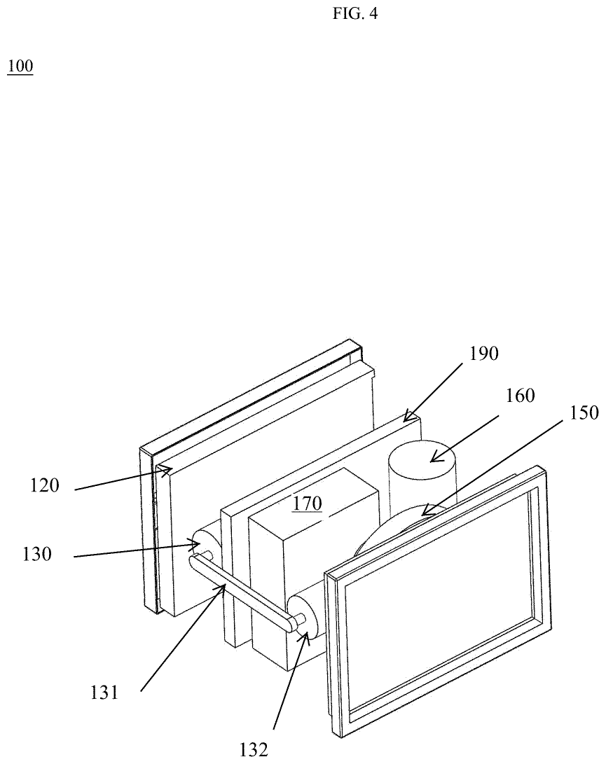

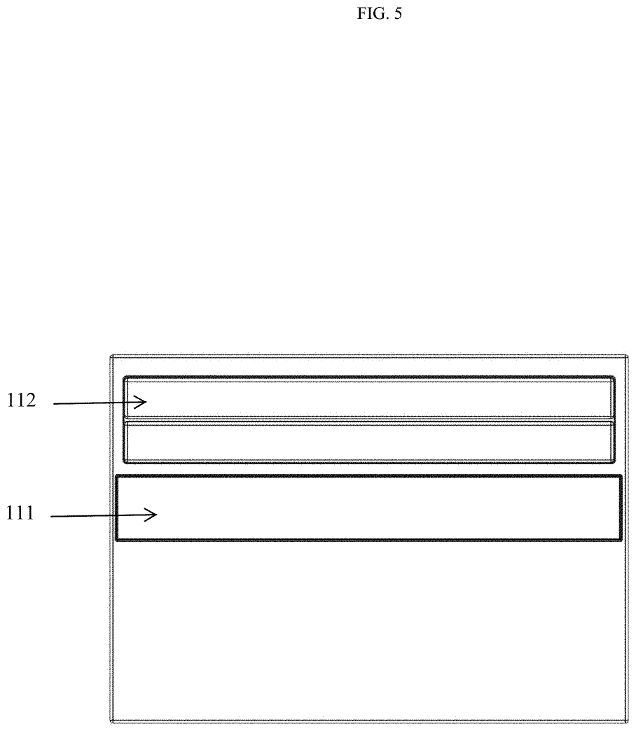

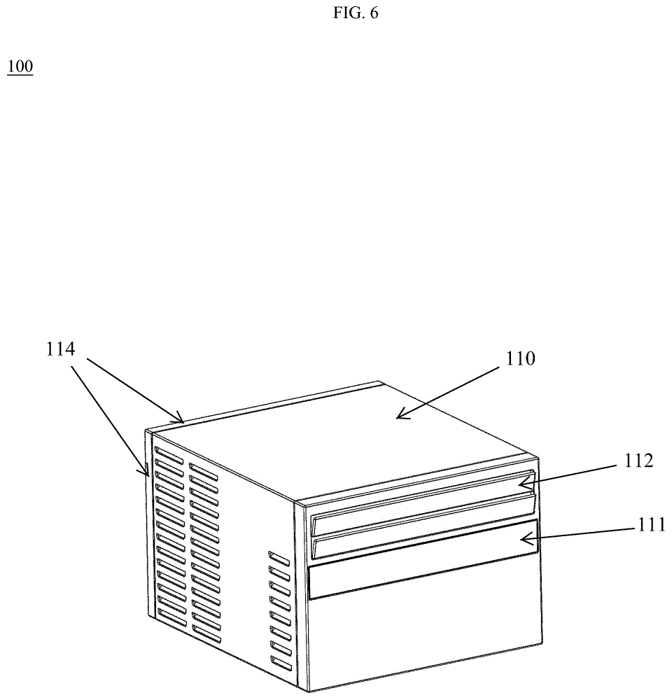

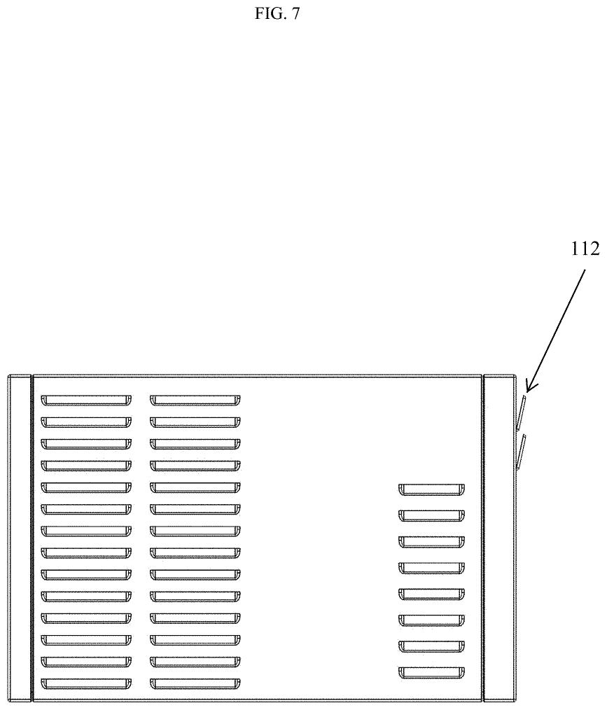

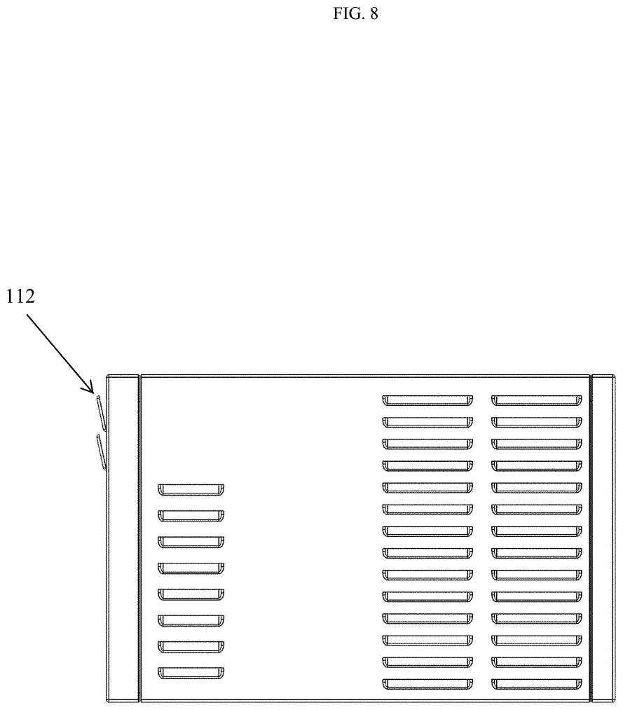

Referring to the figures, FIGS. 1 through 8 generally illustrate various views of a heating/cooling unit 100 designed for use at an indoor room window. With particular reference to FIGS. 3, 4, 5 and 6, there is provided an indoor air treatment unit 100 designed for use at a window adjacent an indoor room, the air treatment unit 100 includes a housing 110 with a control panel 111 and inlet vents 112 on the front of the unit and outlet vents 114 located behind and on opposite sides of the housing 110 to facilitate air flow therethrough. An evaporator coil member 120 is located within the housing, behind the front/control panel 111, and is designed to receive a liquid refrigerant, the evaporator coil member 120 being designed to cool air passing over it. In the preferred embodiment, although not shown, evaporator coils 120 shall extend from the bottom of the unit and extend up to just below the discharge grill or vents 112. A first fan 130 and cross flow blower unit 132 are coupled via a belt 131 and are located within the housing 110 and adjacent the evaporator coil member 120, the first fan 130 and cross flow blower unit 132 designed to provide indoor air from the inlet vents 112 and over the evaporator coil member 120. A condenser coil member 140 is located within the housing 110 adjacent the outlet vents 114, the condenser coil member 140 being designed to provide a liquid refrigerant to the evaporator coil member 120 and receive the refrigerant in the form of a heated gas from the evaporator coil member 120. A second fan 150 and fan blower unit 152 is located within the housing 110 and adjacent the condenser coil member 140 and designed to pass outdoor air over the condenser coil member 140.

In this example embodiment, an inverter compressor unit 160 is located within the housing 110 and coupled to the condenser coil member 140, the inverter compressor unit 160 being designed to convert the heated refrigerant gas received into the liquid refrigerant. Also included is a printed circuit board 170 with a controller designed to provide control signals to the inverter compressor 160 and to the first and the second fan blower units 130/132 and 150/152, respectively. Unit 100 further includes a reverse valve unit 180 located within the housing 110 and is operatively coupled to the inverter compressor 160 and is designed to be responsive to the printed circuit board and controller 170.

In this example embodiment, the heating/cooling unit 100 further includes a thermal and sound insulative barrier 190 located within the housing and separating the evaporator coil member 120 and condenser coil member 140. Unit 100 also includes a touchpad controller (or control panel 111) on an external surface of the housing adjacent the inlet vents which is a capacitive touch device in this embodiment. The capacitive touch buttons are: Filter Reset, Timer, Fan, Mode, Sleep, WIFI, and all “+” and “−” symbols. Everything on the control panel is lit up with LED lighting. All LED's for text and number are white, all LED's for selection indicators are yellow except for the red LED for Filter Reset and the blue LED for the power button. The control brightness can be adjusted with the “+” and “−” symbols on either side of the sun icon.

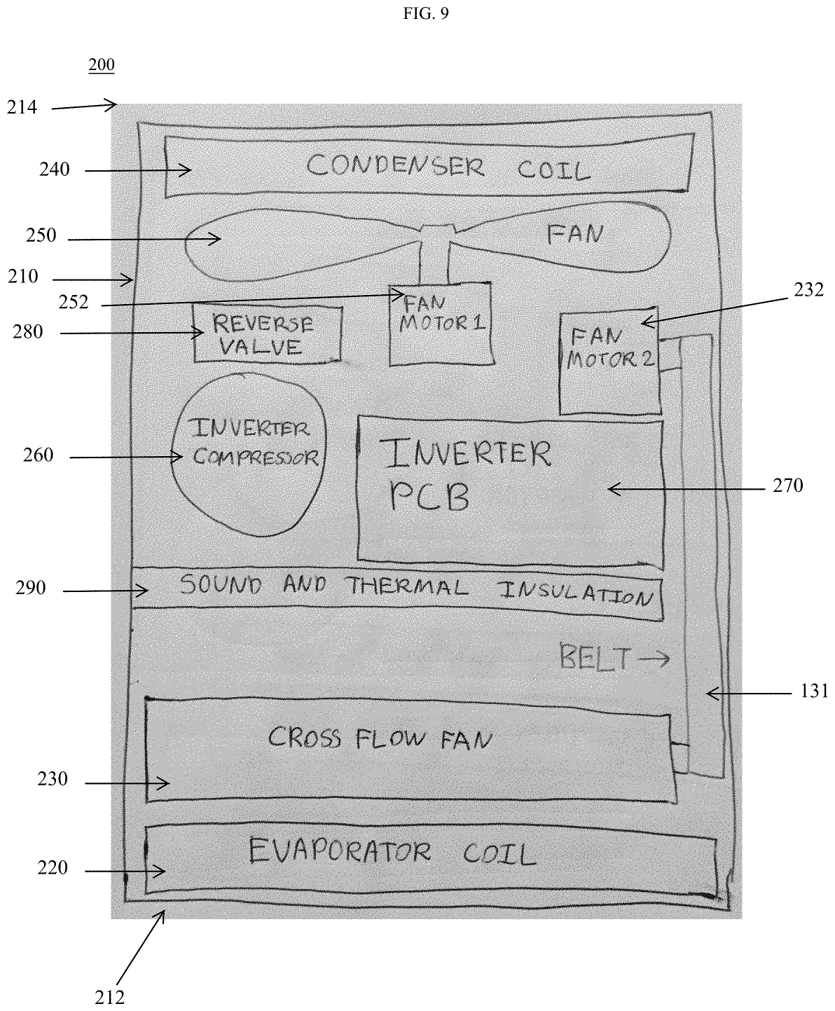

Referring now to FIG. 9, there is illustrated another embodiment of an air treatment unit 200 for providing heating and cooling from a single window mounted unit not requiring ductwork or special electrical connections. In particular, the air treatment unit 200 includes a housing 210 with a control panel 211 (not shown, but similar to panel 111) and inlet vents 212 on the front of the unit and outlet vents 214 located behind and on opposite sides of the housing 210 to facilitate air flow therethrough. An evaporator coil member 220 is located within the housing, behind the front/control panel 211, and is designed to receive a liquid refrigerant, the evaporator coil member 220 being designed to cool air passing over it. In the preferred embodiment, although not shown, evaporator coils 220 shall extend from the bottom of the unit and extend up to just below the discharge grill or vents 212. A first fan 230 and cross flow blower unit 232 are coupled via a belt 231 and are located within the housing 210 and adjacent the evaporator coil member 220, the first fan 230 and cross flow blower unit 232 designed to provide indoor air from the inlet vents 212 and over the evaporator coil member 220. A condenser coil member 240 is located within the housing 210 adjacent the outlet vents 214, the condenser coil member 240 being designed to provide a liquid refrigerant to the evaporator coil member 220 and receive the refrigerant in the form of a heated gas from the evaporator coil member 220. A second fan 250 and fan blower unit 252 is located within the housing 210 and adjacent the condenser coil member 240 and designed to pass outdoor air over the condenser coil member 240.

In this example embodiment, an inverter compressor unit 260 is located within the housing 210 and coupled to the condenser coil member 240, the inverter compressor unit 260 being designed to convert the heated refrigerant gas received into the liquid refrigerant. Also included is a printed circuit board 270 with a controller designed to provide control signals to the inverter compressor 260 and to the first and the second fan blower units 230/232 and 250/252, respectively. Unit 200 further includes a reverse valve unit 280 located within the housing 210 and is operatively coupled to the inverter compressor 260 and is designed to be responsive to the printed circuit board and controller 270.

In this example embodiment, the heating/cooling unit 200 further includes a thermal and sound insulative barrier 290 located within the housing and separating the evaporator coil member 220 and condenser coil member 240. Unit 200 also includes a touchpad controller (or control panel 211) on an external surface of the housing adjacent the inlet vents which is a capacitive touch device in this embodiment.

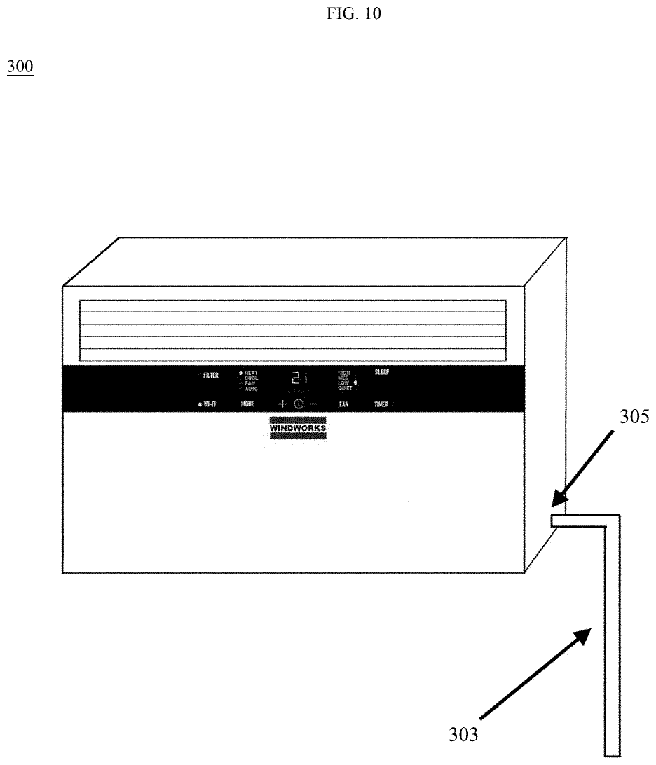

Referring now to FIG. 10, there is illustrated an example embodiment of a window air treatment unit 300 in which a drain pipe is provided for internal drainage of condensate or for connection to existing steam or hot water pipe system. In this embodiment, unit 300 includes an indoor drain pipe 303 coupled to a connection 305 on a side of unit 300 that is provided for internal drainage of condensate. Drain pipe 303 can be connected to existing steam or hot water pipe systems in a home or other building when boilers and radiators are removed from the building. New drain lines can also be installed in the building when using air treatment unit 300, for example.

The above described inventive concept provides the advantages of a new component layout for an indoor air treatment unit that features more space for air flow. The described unit provides both heating and cooling year-round and a quieter performance than the typical window air conditioner. There is also no need to remove this air treatment unit during colder seasons. A capacitive touch control panel provides a modern and decorative element to the room and a brightness of control panel can be adjusted for low light conditions.

The following patents are incorporated by reference in their entireties: U.S. Pat. Nos. 6,568,201; 9,970,669; and 10,752,089.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

I claim:

1. An indoor air treatment unit adapted for use at a window adjacent an indoor room, the air treatment unit comprising:
a housing with inlet vents and outlet vents located thereon and on opposite sides of the housing to facilitate air flow therethrough;
an evaporator coil member located within the housing and adapted to receive a liquid refrigerant, the evaporator coil member adapted to cool air passing over it;
a first fan and cross blower unit located within the housing and adjacent the evaporator coil member, the first fan and cross blower unit adapted to provide indoor air from the inlet vents and over the evaporator coil member;
a condenser coil member located within the housing adjacent the outlet vents, the condenser coil member adapted to provide a liquid refrigerant to the evaporator coil member and receive the refrigerant in the form of a heated gas from the evaporator coil member;
a second fan and fan blower unit located within the housing and adjacent the condenser coil member adapted to pass or direct outside air from the outlet vents;
an inverter compressor unit located within the housing and coupled to the condenser coil member, the inverter compressor unit adapted to convert the heated refrigerant gas received into the liquid refrigerant upon being actuated;
a printed circuit board with a controller adapted to provide control signals to the inverter compressor, the first and the second fan blower units; and
a reverse valve unit located within the housing and coupled to the inverter compressor and adapted to be responsive to the printed circuit board and controller.

2. The air treatment unit of claim 1 further comprising a thermal and sound insulative barrier located within the housing and separating the evaporator coil member and condenser coil member.

3. The air treatment unit of claim 1 further comprising a touchpad controller on an external surface of the housing adjacent the inlet vents.

4. The air treatment unit of claim 2 further comprising a touchpad controller on an external surface of the housing adjacent the inlet vents.

5. The air treatment unit of claim 1 further comprising a drain pipe coupled to and protruding from a side of the housing adapted for connection to a steam or hot water pipe system.

6. The air treatment unit of claim 1 wherein the cross flow fan is a belt-driven cross flow fan arrangement adapted for reduced space requirements.

7. The air treatment unit of claim 1 further comprising.
